(19) United States
(12) Patent Application Publication
(10) Pub. No.: US 2013/0144660 A1
(43) Pub. Date: Jun. 6, 2013

(54) ELECTRONIC MAITRE D'

(71) Applicant: John Christopher Martin, Stamford, CT (US)

(72) Inventor: John Christopher Martin, Stamford, CT (US)

(73) Assignee: VERIZON PATENT AND LICENSING INC., Basking Ridge, NJ (US)

(21) Appl. No.: 13/310,164

(22) Filed: Dec. 2, 2011

(51) Int. Cl. G06Q 10/02

(52) U.S. Cl. 705/5

(57) ABSTRACT

A device may receive reservation information from a user via a user device. The reservation information includes information identifying a user or a user device and information identifying one or more resources that include a first resource. The device may also select the first resource based on the reservation information, determine whether the user device will take less than a threshold time to arrive at a premises, and notify a device associated with a member at the premises when the device determines that the user device will take less than the threshold time to arrive at the premises. The member is to prepare the first resource.

### BACKGROUND INFORMATION

Some hand-held communication devices today provide consumers with access to information that is dependent on the consumers' physical locations. For example, a smart phone may include a Global Positioning System (GPS) application that displays the location of a user of the smart phone. In another example, the smart phone may include a search application that can provide a list of shops in the user's proximity.

### BRIEF DESCRIPTION OF THE DRAWINGS

FIG. 1 is illustrates an exemplary environment in which concepts described herein may be implemented;

FIGS. 2A and 2B are the front and rear views of the exemplary device of FIG. 1;

FIG. 3 is a block diagram illustrating exemplary components of a network device of FIG. 1;

FIG. 4 is a block diagram illustrating exemplary functional components of a user device of FIG. 1;

FIG. 5 is a block diagram illustrating exemplary functional components of an electronic maitre d' device of FIG. 1;

FIG. 6 illustrates an exemplary graphical user interface (GUI) that is associated with the user device of FIG. 1;

FIG. 7 illustrates an exemplary layout of tables in a restaurant;

FIG. 8 is a flow diagram of an exemplary process that is associated with operation of the user device, the electronic maitre d' device, and the maitre d' interface device of FIG. 1; and

FIG. 9 illustrates an example associated with the operation of the user device, the electronic maitre d' device, and the maitre d' interface device of FIG. 1.

### DETAILED DESCRIPTION OF PREFERRED EMBODIMENTS

The following detailed description refers to the accompanying drawings. The same reference numbers in different drawings may identify the same or similar elements.

As described below, a maitre d' device is associated with an entity (e.g., a person, a legal entity (e.g., a corporation, partnership, etc.), etc.) and an establishment (e.g., a store, rental shop, restaurant, etc.). The maitre d' device may allow a user to make a reservation via a user device. When making the reservation, the user device may provide information that identifies the location of the user device. The maitre d' device may store the information, an identification of the user device/user, and a timestamp of the reservation. In addition, when making the reservation, the user may pay for a service and/or a product (e.g., a table, a parking space, a boat, food, flowers, etc.).

After making the reservation, based on the user's location and an approximate travel time, the maitre d' device may prompt or notify members of the establishment to prepare for the arrival of the user (e.g., prepare an entree, clear a space, etc.). Accordingly, when the user arrives at the establishment, the user may conduct a transaction that is associated with the reservation in an efficient and orderly manner (e.g., rent a piece of equipment, eat a meal, etc.).

For example, assume that John has a limited amount of time for lunch. John would like to go to a sit-down restaurant X and have lunch as soon as possible after being seated. Using his smart phone, John orders and pays for a grilled salmon and a glass of cola. Given John's location and the traffic condition when John orders the food, an estimated time of travel for John to arrive at restaurant X is 22 minutes. The grilled salmon requires 14 minutes to prepare. Seven minutes after John places the order, the chef at restaurant X is given John's order for the grilled salmon, and the chef begins to cook. Cola requires 2 minutes to have it ready for John. The bartender at the restaurant is given John's order for cola 19 minutes after John places his order. When John arrives at the restaurant, John is seated at the table reserved for John. A waitress immediately serves John with a grilled salmon and cola. Since the meal has already been paid for, John leaves as soon he finishes eating.

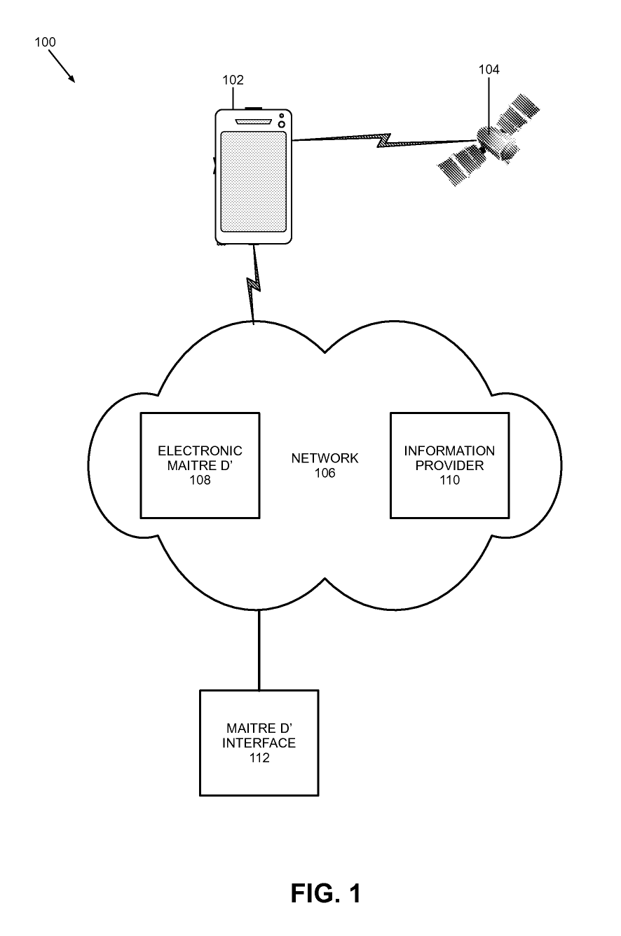

FIG. 1 shows an exemplary environment 100 in which concepts described herein may be implemented. As shown, environment 100 may include a user device 102, one or more location devices 104, a network 106, which in turn may include an electronic maitre d' device 108 and an information provider device 110, and maitre d' interface device 112.

User device 102 may include any of the following devices that have the ability to or are adapted to communicate with another device and/or host an application: a mobile telephone, a personal digital assistant (PDA), an electronic notepad, a tablet computer, a laptop computer, a portable digital television, a gaming console, a media playing device, a wireless/Bluetooth-enabled communication device, etc. User device 102 may obtain its own location based on signals from location devices 104, components (e.g., software and hardware components) within user device 102, and/or other devices in network 106.

In addition, user device 102 includes a graphical user interface (GUI) component. Via the GUI component, the user may make a reservation at electronic maitre d' device 108. While making the reservation, the user may purchase a product and/or a service. For example, assume that electronic maitre d' device 108 includes a software application that receives reservations for a restaurant and that a user is at her house, approximately 30 minute drive from the restaurant. In such a case, the user may reserve a table, select an entree for each member of her party, prepay for the meals, etc.

In some implementations, while making a reservation, user device 102 may receive, with the user's permission, a software component (e.g., piece of software, script, application, applet, program, etc.) from electronic maitre d' device 108 that monitors the location of user device 102 and outputs location information. User device 102 may send the location information to electronic maitre d' device 108.

Location devices 104 may provide signals from which a device (e.g., user device 102) may determine the location of the device. Examples of location devices 104 may include cellular transmission towers, global positioning system (GPS) satellites, Galileo satellite system (GSS) satellites, Beidu navigation system satellites, etc.

Network 106 may include one or more wired or optical networks that are capable of exchanging information, such as voice, video, documents, multimedia, text, etc. For example, network 106 may include one or more public switched telephone networks (PSTNs) or another type of switched network. Network 106 may also include one or more wireless networks and may include a number of transmission towers for receiving wireless signals and relaying the received signals toward the intended destinations. Network 106 may further include one or more packet switched networks, such as an IP based network, a local area network (LAN), a wide area network (WAN) (e.g., a wireless fidelity (Wi-Fi), Wi-Max, etc.) network, a personal area network (PAN), an intranet, the Internet, or another type of network that is capable of exchanging information.

As further shown in FIG. 1, network 106 may include an electronic maitre d' device 108 and information provider device 110. For simplicity, network 106 of FIG. 1 does not show other network components, such as routers, switches, bridges, gateways, servers, etc. or interconnections. Network 106 may include fewer, additional, different, or differently arranged devices than those illustrated in FIG. 1. For example, in one embodiment, network 106 may include additional electronic maitre d' devices and/or information provider devices.

Electronic maitre d' device 108 (also called electronic maitre d' 108) may include one or more programs that perform functions of a host or a maitre d', for example, for one or more entities and establishments (e.g., hotels, restaurants, rental stores (e.g., boat, cars, etc.), cafes, florists, shops/stores, bakeries, butcheries, groceries, etc.) that are associated with the entities. For example, a company or a person (e.g., entity) may be associated with a restaurant (establishment).

In one implementation, as a user travels toward an establishment, electronic maitre d' device 108 may determine which resources (e.g., table/seats in a restaurant, rental car, etc.) have become newly available. If particularly desirable resources have become available, electronic maitre d' device 108, may reassign the resources to the user, or alternatively, send a message to the user, asking whether the user wishes to be reassigned to the newly available resources.

In some implementations, while making the reservation, electronic maitre d' device 108 may send, with the user's authorization, a program (e.g., script, instructions, applet, etc.) to user device 102. As the user travels toward the establishment, the program may periodically monitor user's location, and send location information of the user to electronic maitre d' device 108. Based on the location information, electronic maitre d' device 108 may estimate the time of travel for the user and the arrival time of the user at the establishment, and use the estimated arrival time to prepare the resource (e.g., arrange tables, begin to prepare meals, clean rental device, etc.).

To estimate the arrival time, electronic maitre d' device 108 may consult its own databases of routes and travel times that are associated with the routes. Alternatively, electronic maitre d' device 108 may query information provider device 110, with information that identifies the locations of user device 102 and the establishment. In other implementations, electronic maitre d' device 108 may use the reservation time as the approximate time of arrival.

Information provider device 110 may receive queries from network devices. Each query may include information that identifies two locations. Based on the location information, information provider device 110 may estimate the time of travel between the two locations. To estimate the travel time, information provider device 110 may determine a path from one of the two locations to the other location, break down the path into segments, estimate the travel time for each of the segments, and aggregate/accumulate the travel times for the segments to obtain the overall estimated travel time. In obtaining a travel time for each of the segments, information provider device 110 may factor in weather conditions, the time of the day, the traffic condition, the mode of transportation (e.g., airplane, automobile, by foot, boat, etc.), etc.

Maitre d' interface device 112 may receive reservation information that is relayed by a member of an establishment (e.g., restaurant) from a user (e.g., over a telephone). Maitre d' interface device 112 may send the reservation information to electronic maitre d' device 108. The reservation information may include payment information, the location of the user, seats/table selected by the user, etc.

Maitre d' interface device 112 may also receive information that changes a status of the user (e.g., the user has left the establishment, a user has cancelled a reservation, etc.). Upon receipt of the information, maitre d' interface device 112 may forward the information to electronic maitre d' device 108.

In FIG. 1, the number of devices and the configuration in environment 100 are exemplary and provided for simplicity. According to other embodiments, environment 100 may include additional devices, fewer devices, different devices, and/or differently arranged devices, than those illustrated in FIG. 1. Additionally, the number and type of networks in environment 100 are exemplary and provided for simplicity.

According to other embodiments, a single device in FIG. 1 may be implemented as multiple devices and/or multiple devices may be implemented as a single device. A device may be implemented according to a centralized computing architecture, a distributed computing architecture, or a cloud computing architecture. Additionally, a device may be implemented according to one or multiple network architectures (e.g., a client device, a server device, a peer device, or a combination thereof).

Also, according to other embodiments, one or more functions and/or processes described as being performed by a particular device may be performed by a different device, or some combination of devices. Environment 100 may be implemented to include wired and/or wireless connections among the devices illustrated.

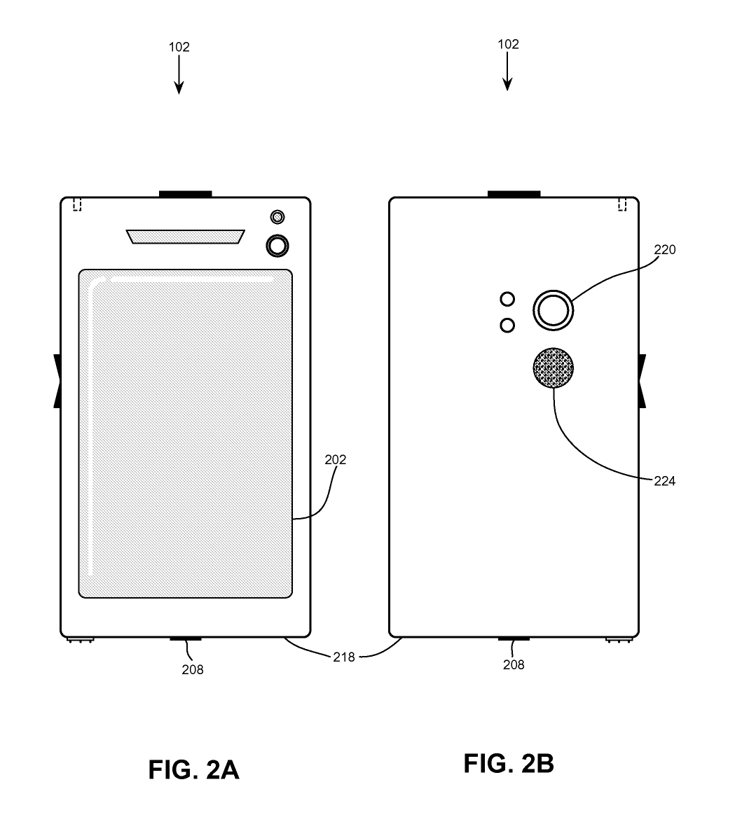

FIGS. 2A and 2B are front and rear views of user device 102 according to one implementation. In FIGS. 2A and 2B, user device 102 is shown as a smart phone. As shown in FIGS. 2A and 2B, user device 102 may include a display 202, microphone 208, housing 218, rear camera 220, and speaker 224. Depending on the implementation, user device 102 may include additional, fewer, different, or a different arrangement of components than those illustrated in FIGS. 2A and 2B.

Display 202 may provide visual information to the user. In some implementations, display 202 may also include a touch screen that can sense contacting a human body part (e.g., finger) or an object (e.g., stylus). Microphone 208 may receive audible information and/or sounds from the user and from the surroundings. Housing 218 may provide a casing for components of user device 102 and may protect the components from outside elements. Rear camera 220 may enable the user to view, capture, store, and process images of a subject in/at back of user device 102. Speaker 224 may provide audible information from user device 102 to a user/viewer of user device 102.

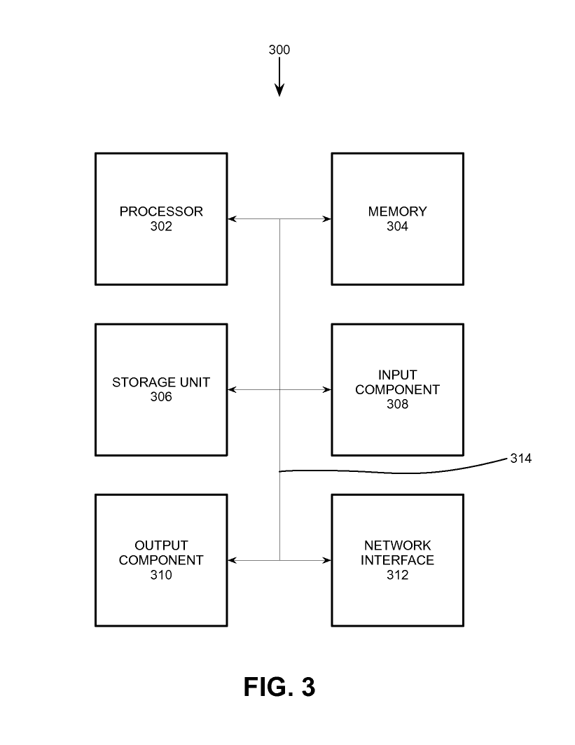

FIG. 3 is a block diagram of exemplary components of a network device 300. Each of user device 102, electronic maitre d' device 108, information provider device 110, and maitre d' interface device 112 may include one or more of network device 300. As shown, network device 300 may include a processor 302, memory 304, storage unit 306, input component 308, output component 310, network interface 312, and communication path 314. In different implementations, network device 300 may include additional, fewer, different, or different arrangement of components than the ones illustrated in FIG. 3. For example, network device 300 may include line cards for connecting to external buses.

Processor 302 may include a processor, a microprocessor, an Application Specific Integrated Circuit (ASIC), a Field Programmable Gate Array (FPGA), and/or other processing logic (e.g., embedded devices) capable of controlling network device 300. Memory 304 may include static memory, such as read only memory (ROM), and/or dynamic memory, such as random access memory (RAM), or onboard cache, for storing data and machine-readable instructions (e.g., programs, scripts, etc.). Storage unit 306 may include a floppy disk, CD ROM, CD read/write (R/W) disc, and/or flash memory, as well as other types of storage devices (e.g., hard disk drive) for storing data and/or machine-readable instructions (e.g., a program, script, etc.). As used herein, the term “computer-readable medium” may include memory 304, storage unit 306, or a combination of the two.

Input component 308 and output component 310 may provide input and output from/to a user to/from network device 300. Input/output components 308 and 310 may include a display screen, a keyboard, a mouse, a speaker, a microphone, a camera, a DVD reader, Universal Serial Bus (USB) lines, and/or other types of components for converting physical events or phenomena to and/or from signals that pertain to network device 300.

Network interface 312 may include a transceiver (e.g., a transmitter and a receiver) for network device 300 to communicate with other devices and/or systems. For example, via network interface 312, network device 300 may communicate over a network, such as the Internet, an intranet, a terrestrial wireless network (e.g., a WLAN, WiFi, WiMax, etc.), a satellite-based network, optical network, etc. Network interface 312 may include a modem, an Ethernet interface to a LAN, and/or an interface/connection for connecting network device 300 to other devices (e.g., a Bluetooth interface).

Communication path 314 may provide an interface through which components of network device 300 can communicate with one another.

Network device 300 may perform processes and/or functions, in response to processor 302 executing software stored by memory 304 and/or storage unit 306. For example, the instructions may be read into memory 304/storage unit 306 from another memory 304/storage unit 306 or from another device via network interface 312. The instructions stored by memory 304/storage unit 306 may cause processor 302 to perform one or more processes described herein. Alternatively, for example, according to other implementations, device 300 may perform one or more processes described herein based on the execution of hardware (processor 302, etc.), the execution of firmware with hardware, or the execution of software and firmware with hardware.

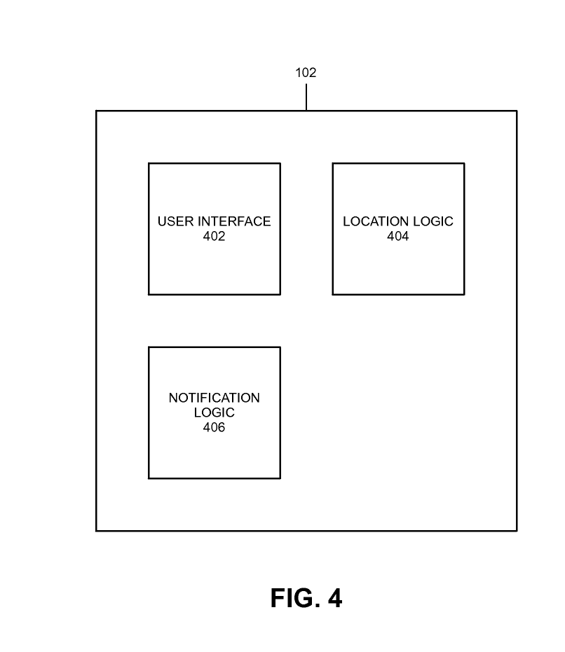

FIG. 4 is a block diagram illustrating exemplary functional components of user device 102. As shown, user device 102 may include a user interface 402, location logic 404, and notification logic 406. For simplicity, user device 102 of FIG. 4 does not show other components, such as an operating system (e.g., Windows, Linux, etc.), drivers, an application (e.g., an email client, a word processor, a browser, etc.), a database, etc. Furthermore, depending on the embodiment, user device 102 may include additional, fewer, or different functional components than those illustrated in FIG. 4.

User interface 402 may receive reservation information from a user. The reservation information may include information that: identifies the user or user device 102; identifies the location of user device 102; identifies the user's selection of resources (e.g., entrees, rental equipment, table, seats, etc.); and/or includes payment information. In some implementations, user interface 402 may obtain the user's authorization to accept, at user device 102, a program (e.g., script, applet, etc.) from electronic maitre d' device 108, for monitoring the location of user device 102 for a specific amount of time (e.g., two hours, one day, etc.).

In some instances, user interface 402 may receive notifications from electronic maitre d' device 108 about updates to available resources at an establishment associated with electronic maitre d' device 108. For example, electronic maitre d' device 108 may notify user interface 402 that a new table/seats have become available at a restaurant at which the user has made a reservation, and prompt the user, via user device 102, to indicate whether the user would like to upgrade to the new table/seats. If the user does not reply within a given amount of time (e.g., 3 minutes), user interface 402 may disable the prompt.

Location logic 404 may determine the location of user device 102 based on information from location device 104. Location logic 404 may output location information based on the determined location. Location logic 104 may provide the location information to another component in user device 102, such as notification logic 406, a navigation program, etc.

Notification logic 406 may include a program that is installed on storage unit 306 of user device, or alternatively, temporarily resident in memory 304. In some implementations, notification logic 406 may have been downloaded from electronic maitre d' device 108 with the user's permission. Periodically or upon receipt of a demand from electronic maitre d' device 108 (via user interface 402), notification logic 406 may query location logic 404 to obtain location information for user device 102. Notification logic 406 may send the location information to electronic maitre d' device 108.

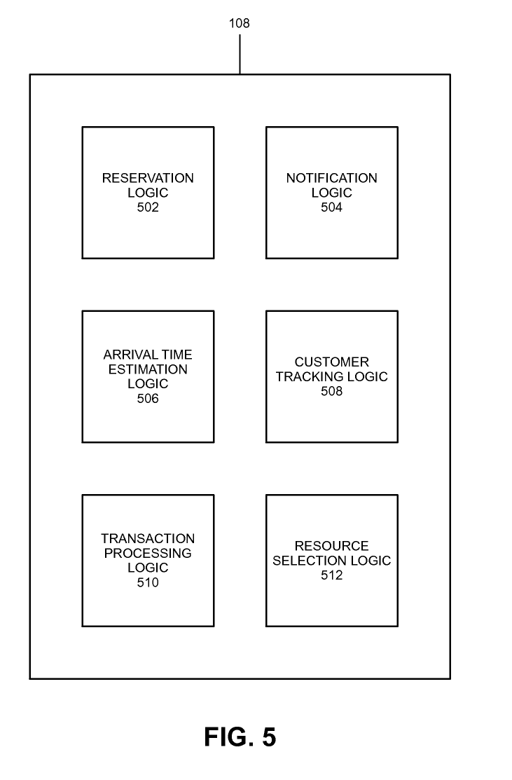

FIG. 5 is a block diagram illustrating exemplary functional components of electronic maitre d' device 108. As shown, electronic maitre d' device 108 may include reservation logic 502, notification logic 506, arrival time estimation logic 506, customer tracking logic 508, transaction processing logic 510, and resource selection logic 512. Depending on the implementation, electronic maitre d' device 108 may include additional, fewer, different, or differently arranged components than those illustrated in FIG. 5.

Reservation logic 502 may receive reservation information from user device 102 or from maitre d' interface device 112. The reservation information may include, for example, a telephone number associated with user device 102; a name associated with the user; the time of reservation; a list of selected resources for the user (e.g., a list of selected seats/table, list of entrees, etc.); an identifier for the business establishment; and/or payment information. In receiving or processing the payment information and the list of selected resources, reservation logic 502 may use/consult transaction processing logic 510 and resource selection logic 512, respectively. While making a reservation, reservation logic 502 may request and obtain location information from user device 102 (from either location logic 404 or based on user input).

Notification logic 504 may periodically scan, for each of? the list of users that are scheduled to arrive at an establishment, and for each user, may determine the amount of time until the arrival via arrival time estimation logic 506. If the amount of time until the arrival is less than a threshold time, notification logic 504 may notify or instruct an appropriate staff member (e.g., a cook at a restaurant), for example, to prepare a particular resource. To notify the member, notification logic 504 may send a message (e.g., a voice message, text message, etc.), for example, to a device associated with the member (e.g., a pager, a smart phone).

In some implementations, notification logic 504 in electronic maitre d' device 108 may determine when a user that has made a reservation is close to an establishment (via arrival time estimation logic 506 and customer tracking logic 508). If the user is travelling toward the establishment and is to arrive at the establishment within a threshold time (e.g., based on the user's travel speed and direction), electronic maitre d' device 108 may send a message to the user whether the user is coming to the establishment. If the user answers in the affirmative, electronic maitre d' device 108 may notify the members of the establishment to prepare a resource (e.g., a product/service) that the user has arranged to purchase/rent. In a different implementation, notification logic 502 may simply notify the members of the establishment to prepare the resource.

Arrival time estimation logic 506 may determine, for a user, the amount of time until the arrival of the user at an establishment. In one implementation, for a user, arrival time estimation logic 506 may determine the amount of time based on the current time and the time for which the reservation was made. For example, if the current time is 5:45 p.m., and the reservation time is 6:00 p.m., arrival time estimation logic 506 may output 15 minutes.

In another implementation, arrival time estimation logic 506 may determine the location of the user based on the output of customer tracking logic 508, to obtain location information. Arrival time estimation logic 506 may then query information provider device 110, based on the location information and information identifying the location of the establishment at which the reservation is made. Arrival time estimation logic 506 may provide the approximate travel time obtained from information provider device 110 as its output to notification logic 504.

Customer tracking logic 508 may receive, for each user, location information for the user, from a corresponding user device 102. In some implementations, customer tracking logic 508 may request user device 102 for the information. In other implementations, user device 102 may send the information to customer tracking logic 508 without receiving the request from electronic maitre d' device 108.

Transaction processing logic 510 may receive payment information from user device 510. Depending on the implementation, reservation logic 502 may or may not request user device 102 for payment information. When the user sends the payment information (e.g., credit card number, the expiration date of a credit card, etc.), transaction processing logic 510 may initiate and/or complete a transaction between an entity associated with the establishment and the user, for the payment, for example, for resources.

Resource selection logic 512 may receive, from user device 102 (via reservation logic 502), a request to provide a list of available resources in an establishment, and provide the requested information to user device 102. In addition, resource selection logic 512 may receive, via reservation logic 502, user selection of resources at the establishment. Resource selection logic 512 may associate the identity of the establishment, a time of the reservation, the selected resource(s), and members of the party. Resource selection logic 512 may store the association in a database, table, etc., within storage unit 306.

Resource selection logic 512 may receive updated status of resources from maitre d' interface device 112, when a user arrives or leaves an establishment. Resource selection logic 512 may also receive information about freed resources from user device 102, which may also cancel reservations.

When resource selection logic 512 receives resource status information from user device 102 or maitre d' interface device 112, resource selection logic 512 may optimize or attempt to optimize the assignment or reservation of the resources at a specified establishment. For example, when resource selection logic 512 receives information about a newly available table (for seating customers) from maitre d' interface device 112 in a restaurant, and determines that the table is available for a given time slot, resource selection logic 512 may scan the current list of users that have made reservations with the restaurant. Resource selection logic 512 may determine, for each of the users, whether a reserved table may be upgraded, based on a number of factors: (1) the number of guests (G) in the user's party and the number of seats (N) for the newly available table; (2) the reservation time; and (3) whether the user has indicated that the user is interested in upgrading the table. If the G<N, the reservation time matches the available time for the newly available table, and the user has indicated an interest in upgrading the table/seats, resource selection logic 512 may identify the user as a candidate.

After resource selection logic 512 identifies one or more candidates, resource selection logic 512 may rank the candidates based on, for example, the sizes of the users' parties, the amount of prior purchases by the users, etc. Starting from the top of the ranked list, resource selection logic 512 may sequentially select a user and notify user device 102 associated with the selected user, that a new table has become available. If resource selection logic 512 in electronic maitre d' device 108 does not receive a reply within a given time (e.g., 2 minutes) or receive a negative reply from user device 108, resource selection logic 512 may select the next user in the ranked list, and prompt user device 102 associated with the next user.

If resource selection logic 512 receives an affirmative reply from user device 102 within the given time, resource selection logic 512 may assign the seats that have become newly available to the selected user, and indicate, in its database, that the table/seats previously assigned to the party are now empty or unassigned. Given the new empty table/seats, resource selection logic 512 may again attempt to optimize the allocation of resources for the establishment.

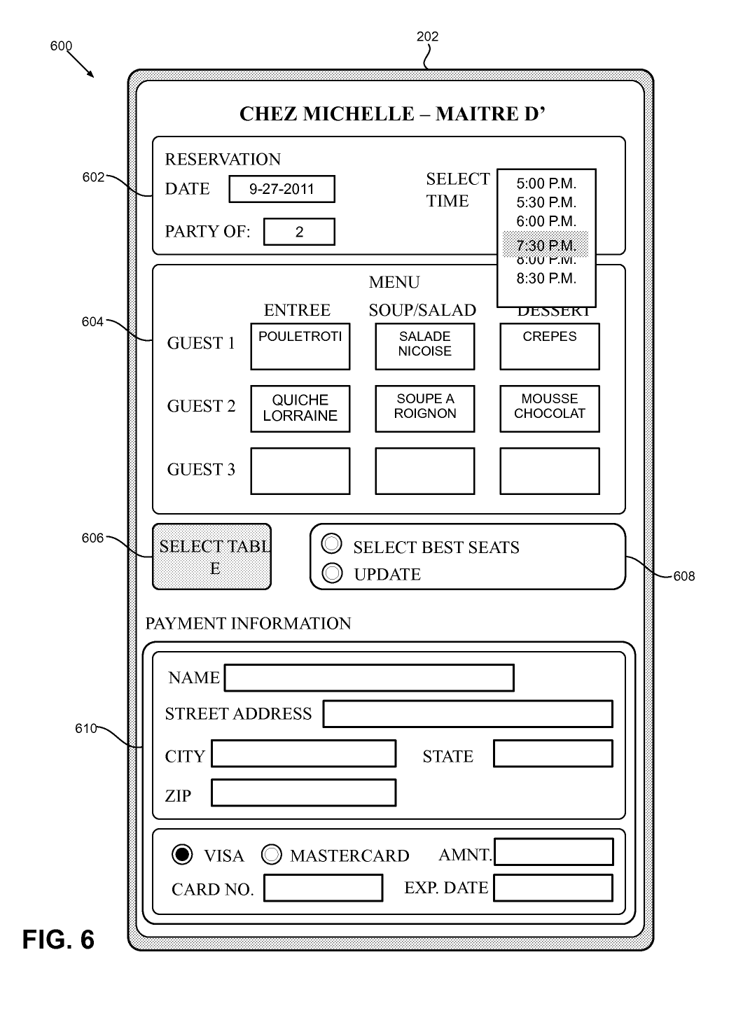

FIG. 6 illustrates an exemplary GUI component 600 that is associated with user device 102. GUI COMPONENT 600 may be implemented as a stand-alone client application, a web page, a script, applet, etc. For example, in one implementation, GUI component 600 may be downloaded from electronic maitre d' device 108 to user device 102/maitre d' interface device 112 when user device 102/maitre d' interface device 112 accesses content at a particular universal resource identifier (URI) (e.g., a URI associated with an establishment). Although GUI COMPONENT 600 is illustrated as a GUI for making reservations at a restaurant, in different implementations, GUI COMPONENT 600 may receive user input for making reservations at other types of establishments, such as a rental shop, florist, bakery, butchery, etc., or any other type of establishment in which the user may initially contact, via user device 102, to “reserve a resource(s),” and the establishment may prepare the resource for the user before the user arrives at the establishment.

As shown, GUI component 600 may include a reservation panel 602, entree/food selection panel 604, table selection button 606, seat selection option panel 608, and payment panel 610. Depending on the implementation, GUI component 600 may include additional, fewer, different, or differently arrangement components than those illustrated in FIG. 6. For example, in one implementation, GUI component 600 may include a component for a user to input selection of wines, appetizers, etc. In another example, payment information panel 610 may provide for a text box for the user to input card verification code/value/data. In yet another, example, in other implementations, GUI component 600 may permit the user to reserve products/services for different types of businesses.

Reservation panel 602 may include component(s) for receiving input data associated with reservation information, such as the number of guests in a user's party, the date and time of the reservation, etc. Entree/food selection panel 604 may include component(s) for receiving user input that specify, for each member of the party, an entree, soup/salad, desert, appetizer, etc. (e.g., resources). In some implementations, entree/food selection panel 604 may allow the user to order appetizer/food for the user's party, rather than a particular member of the party.

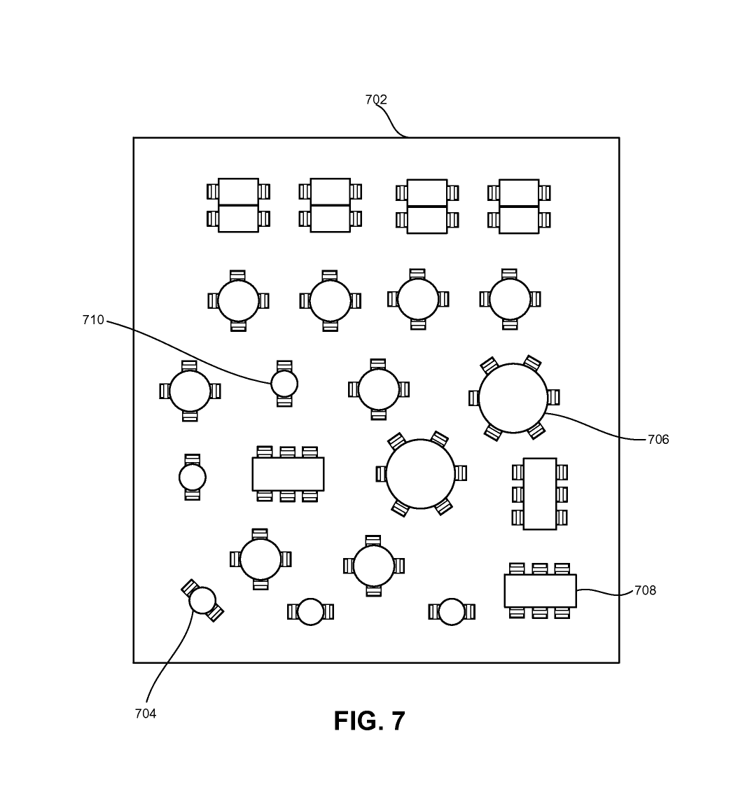

Select table button 606, when activated, may allow the user to select a particular table or seats (e.g., resources in a restaurant). For example, when a user activates button 606 on display 202, user device 102 may show a layout of the restaurant (e.g., downloaded from electronic maitre d' device 108). FIG. 7 shows an exemplary layout 702 of tables and seats in a restaurant. Layout 702 illustrates tables for parties of different sizes, such as a table for two 704, a round table for six 706, a table for six 708, and a table for two 710. Although not illustrated in FIG. 7, available tables/seats may be highlighted in display 202, and may be selectable via typical user input (e.g., touch).

Depending on the implementation, layout 702 may illustrate other features of the restaurant, such as windows, restroom, kitchen, plants, and other features that may influence the user's decision in selecting tables. Furthermore, depending on the implementation, layout 700 may include additional tables, fewer tables, different tables, or different arrangement of tables than those illustrated in FIG. 7.

Returning to FIG. 6, seat selection option panel 608 may include options, associated with seat/table selections, that are available for the user. In FIG. 6, the available options are illustrated as “SELECT BEST SEATS” and/or “UPDDATE.” If UPDATE option is selected, resource selection logic 512 on electronic maitre d' device 108 may alert the user when another table, which seats the same number of or more people, becomes available at the restaurant. Upon receipt of the notification, the user may accept the newly available table/seats. For example, assume that a user selected table 708 for her party of five. When round table 706 becomes available, resource selection logic 512 in electronic maitre d' device 108 may send a notification to user device 108. The user may accept the reassignment of table 706 to the user.

When the user selects the SELECT BEST SEATS OPTION, upon completion of the reservation, resource selection logic 512 may assign seats that are deemed the best (by the criteria of resource selection logic 512) to the user. If both SELECT BEST SEATS and UPDATE options are selected by the user, upon completion of the reservation and when resource selection logic 512 determines that new table/seats have become available, resource selection logic 512 on electronic maitre d' device 108 may reassign the user to the newly available table/seats when resource selection logic 512 determines that the newly available table/seats are superior to the table/seats that are already assigned to the user (e.g., based on its proximity to a window). For example, assume that the user has selected table 710. When table 704 becomes available and resource selection logic 512 determines that table 704 is better than table 702 due to table 704's proximity to windows, resource selection logic 512 may assign table 704 to the user.

Returning to FIG. 6, payment panel 610 may include one or more components for receiving user input for a payment. Payment panel 610 may include, for example, components for receiving user input that specifies a dollar amount, user's name, credit card number, user's address, etc. In some implementations, payment panel 610 may be optional. In such implementations, if the user does not prepay via payment panel 610, the user may pay after the user's party finishes dining at the restaurant.

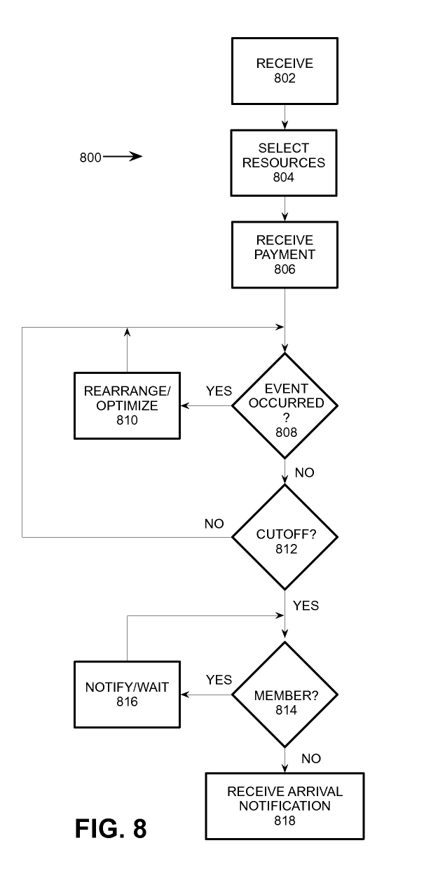

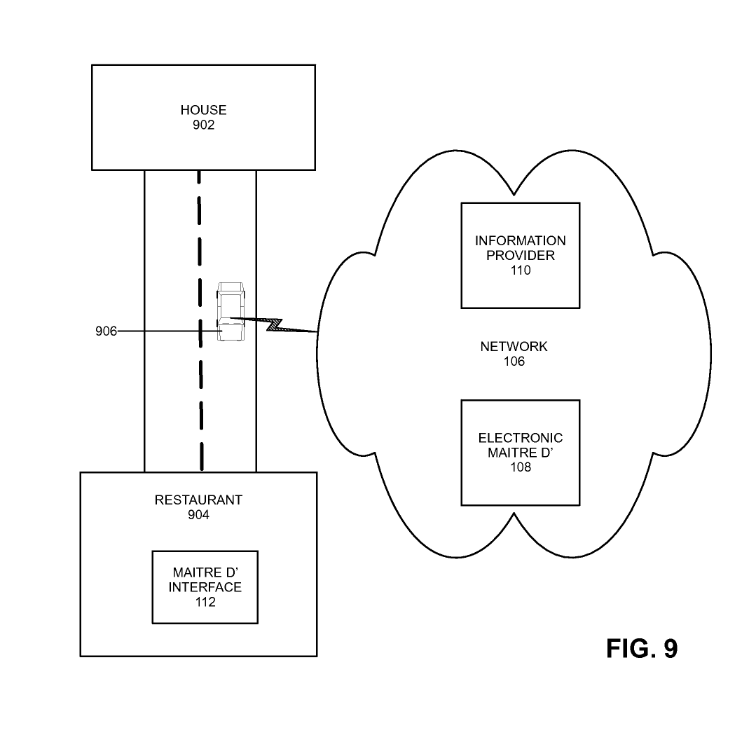

FIG. 8 is a flow diagram of an exemplary process 800 that is associated with operation of user device 102, electronic maitre d' device 108, and maitre d' interface device 112. Process 800 is described with reference to an example associated with the operation of user device 102, electronic maitre d' device 108, and maitre d' interface device 112. FIG. 9 illustrates the example. In the example, assume that Jack and Jill live in house 902 and own a car 906. Furthermore, assume that Jack calls electronic maitre d' device 108 via Jack's user device 102 to make a reservation for two at restaurant 904. Assume that restaurant 904 includes maitre d' interface device 112 in its premises.

Electronic maitre d' device 108 may receive reservation information from a user device 102 (block 802). For example, assume that Jack is at house 902. Via user device 102, Jack may make a reservation at electronic maitre d' device 108. Alternatively, Jack may call restaurant 904. A host/hostess at restaurant 904 may obtain reservation information from Jack over the phone, and enter the reservation information via maitre d' interface device 112. Maitre d' interface device 112 may send the reservation information to electronic maitre d' device 108. As described above, the reservation information may include information that identifies a user selection of resources (e.g., a table, selections of particular dishes (in the case of restaurants), options that are associated with resources, a telephone number of user device 102, a number of people in the user's party, a name, the time and date of the reservation, the user's location, an identity of the establishment, etc.

Electronic maitre d' device 108 may select the resources based on the reservation information (block 804). For example, electronic maitre d' device 108 may select a table for the party. In another example, electronic maitre d' device 108 may select entrees for each of the members of the user's party.

Depending on the implementation, the reservation information may include payment information. The payment information may include the amount due based on the selected resources (e.g., entrees, goods, services, etc.), the prices of the resources at the establishment (e.g., prices of entrees at a restaurant). Electronic maitre d' device 108 may receive a payment (block 806). For example, electronic maitre d' device 108 may complete a transaction involving a credit card company and credit an account of the entity associated with the establishment (e.g., restaurant 904).

Electronic maitre d' device 108 may determine whether an event that frees a resource (e.g., a table at a restaurant) has occurred (block 808). For example, when a party X has finished dining and leaves restaurant 904, a host at restaurant 904 may input, at maitre d' interface device 112, information indicating that party X has left restaurant 904. Maitre d' interface device 112 may relay the information to electronic maitre d' device 108, to indicate that the table has become available to other users. In another example, party X may call restaurant 904 to cancel a reservation. The host may input the cancellation information at maitre d' interface device 112, which may relay the cancellation information to electronic maitre d' device 108. In each of the examples, electronic maitre d' device 108 may determine that the table, a resource, formerly assigned to party X is free to be reassigned to Jack.

If an event that frees a resource occurred (block 808: yes), electronic maitre d' device 108 may rearrange/optimize the resource allocation/assignments (block 810) based on information provided by users (e.g., preferences or requirements associated with resources), resource characteristics, availability, etc. Continuing with the example of FIG. 9, assume that Jack is assigned to table 710, and that a couple that occupied table 704 has left restaurant 904. In such an instance, electronic maitre d' device 108 may scan a list of parties of two (or one) that want their assigned tables upgraded. Assume that Jack has indicated, while making the reservation, that Jack would like the assigned table upgraded if an appropriate opportunity arises. In addition, assume there is another user Bob who has made a reservation via electronic maitre d' device 108 at restaurant 904 and wants his table upgraded.

Upon identifying Jack and Bob, electronic maitre d' device 102 may rank/order Jack and Bob, based on their past visits to restaurant 904, how much each has spent at restaurant 904, etc. Assume that electronic maitre d' device 108 ranks Bob as being ahead of Jack. Consequently, electronic maitre d' device 108 sends Bob a message, indicating that table 704 has become available, and Bob can be reassigned to table 704. Bob does not respond to the message in time, and consequently, electronic maitre d' device 108 then notifies Jack. Jack does respond to the notification, and electronic maitre d' device 108 assigns table 704 to Jack.

After block 810, process 800 may return to block 808, to again determine whether an event that frees a resource has occurred. Continuing with the prior example, because table 710 (which was previously assigned to Jack) has become unassigned, electronic maitre d' device 108 may determine that an event freeing a table/seats has occurred (block 808: yes), and revisits block 810.

Returning to block 808, if the event that frees a resource has not occurred (block 808: no), process 800 may proceed to block 812. At block 812, electronic maitre d' device 108 may determine whether an event that cuts off further optimization/reassignment/reallocation or resources has occurred.

If an event that cuts off further optimization/rearrangement of resources has occurred (block 812: yes), electronic maitre d' device 108 may proceed to block 814. For example, the user may be close to restaurant 904 or the estimated arrival time is less than a threshold. In such an instance, electronic maitre d' device 108 may no longer attempt to reassign a newly available table to Jack, and proceed to block 814. If an event that cuts off further optimization/rearrangement of resources has not occurred (block 812: no), electronic maitre d' device 108 may return to block 808.

Electronic maitre d' device 108 may determine whether there is a member, in the establishment, that is to be notified of a user's arrival time and of a resource(s) that needs to be prepared in anticipation of the user's arrival (block 814). If there is such a member (block 814), electronic maitre d' device 108 may notify the member (e.g., chef at restaurant 904) or simply wait (e.g., the time of arrival is too far away) (block 816). For example, if the time required to prepare a resource (e.g., prepare an entrée) is greater than or equal to the estimated travel time to the establishment, electronic maitre d' device 108 may notify the member. Electronic maitre d' device 108 may then return to block 814. If there is no additional member to be notified (block 814: no), electronic maitre d' device 108 may proceed to block 818, where electronic maitre d' device 108 waits until electronic maitre d' device 108 receives a notification of the user's arrival and departure. Electronic maitre d' device 108 may change statuses of resources accordingly in its database (e.g., indicate that a table is occupied, indicate that a table has been freed, indicate that a resource has been rented out, indicate that a resource has been returned, etc.).

In the above, although the example depicted in FIG. 9 is described in the context of a restaurant business, process 800 may apply to other types of businesses or establishment (e.g., rental business). In these cases, the user can reserve resources or place an order for the resources hours in advance, since the preparation does not begin until the estimate travel time from the user's location is less than or equal to the preparation time of the resource with the longest preparation time.

For example, assume that Jack wants to reserve a small sailboat for a day. Jack calls a sail boat rental company A and makes a reservation via user device 102. Via a graphical user interface, Jack selects various parameters that are associated with the sailboat (e.g., equipment with which the sailboat is to be outfitted). Jack also pays for the rental.

Assume that Jack is 1 hour away from company A when Jack makes the reservation. When Jack is within 45 minutes from company A, electronic maitre d' device 108 notifies employees of company A of Jack's arrival, and the employees prepares the sailboat for Jack (e.g., removing covers, outfitting the sailboat with life jackets, cleaning, etc.). When Jack arrives at company A, Jack may immediately access the sailboat.

In yet another example, Jack wants to purchase a floral arrangement (for Jill) from Mayflower. Jack wants to pick up the floral arrangement later in the day. Jack places an order via user device 102 and electronic maitre d' device 108, which sends the order information to Mayflower. Florists at Mayflower require approximately 10 minutes to trim the flowers and wrap them. Jack leaves his office after a couple of hours and decides to pick up the flowers. Jack begins to walk toward Mayflower.

When electronic maitre d' device 108 determines that Jack's current location, Jack's direction of movement, and Jack's speed places Jack within 15 minutes of Mayflower, electronic maitre d' device 108 sends a message to Jack, requesting Jack to indicate whether Jack is coming to Mayflower. If Jack replies in the affirmative, electronic maitre d' device 108 notifies florists at Mayflower that Jack will arrive at Mayflower within 15 minutes. When Jack arrives at Mayflower, Jack picks up the flowers without waiting.

As described above, electronic maitre d' device 108 is associated with an entity and an establishment (e.g., a store, rental shop, church, etc.). Electronic maitre d' device 108 may allow a user to make a reservation via user device 102. When making the reservation, user device 102 may provide information that identifies the location of user device 102. Electronic maitre d' device 108 may store the information, an identification of user device 102/user, and a timestamp of the reservation. In addition, when making the reservation, the user may pay for a resource or use of the resource (e.g., a table, a parking space, a boat, food, flowers, etc.).

After making the reservation, based on the user's location and an approximate travel time, electronic maitre d' device 108 may prompt or notify members of the establishment to prepare for the arrival of the user (e.g., prepare an entree, clear a space, etc.). Accordingly, when the user arrives at the establishment, the user may conduct a transaction that is associated with the reservation in an efficient and orderly manner (e.g., rent a piece of equipment, eat a meal, etc.).

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments. Further, while series of acts have been described with respect to FIG. 8, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving reservation information from a user via a user device, the reservation information comprising information identifying a user or a user device and information identifying one or more resources that include a first resource;
selecting the first resource based on the reservation information;
determining by one or more processors whether the user device will take less than a threshold time to arrive at a premises; and
notifying a device associated with a member, at the premises, that is to prepare the first resource when the one or more processors determine that the user device will take less than the threshold time to arrive at the premises.

2. The method of claim 1, further comprising:
completing a purchase associated with the first resource or a transaction associated with the first resource.

3. The method of claim 1, wherein determining whether the user device will take less than a threshold time to arrive at the premises includes:
obtaining location information that identifies a location of the user device; and
determining an approximate amount of time that the user device will take to arrive, from the location, at the premises.

4. The method of claim 3, wherein determining an approximate amount of time includes:
determining the approximate amount of time by querying a remote device with a message, the message including at least the location information.

5. The method of claim 3, wherein determining an approximate amount of time includes:
determining a travel speed of the user device, a moving direction of the user device, and the location of the user device; and
determining an amount of time the user device will take to reach the premises based on the travel speed, the moving direction, and the location.

6. The method of claim 3, wherein determining an approximate amount of time includes:
determining a difference between a time for the reservation and a current time.

7. The method of claim 1, wherein the notifying a device associated with the member includes at least one of:
notifying a chef to prepare an entree; or
notifying a bartender to prepare a drink,

8. The method of claim 1, further comprising:
receiving information that indicates availability of a second resource;
reserving the second resource to the user; and
freeing the first resource.

9. The method of claim 8, wherein the receiving information that indicates availability of the second resource includes:
receiving information that indicates availability of the second resource from an interface device in the premises.

10. The method of claim 1, further comprising:
sending a component, to the user device, that obtains location information that identifies a location of the user device when the component resides on the user device.

11. A system comprising:
a device comprising:
a network interface via which the device communicates with other devices;
a memory to store processor-executable instructions;
a processor to execute the instructions to:
receive reservation information from the user device, the reservation information comprising information identifying a user of the user device or the user device and information identifying one or more resources that include a first resource;
select the first resource based on the reservation information;
determine whether the user device will take less than a threshold time to arrive at a premises; and
notify a device associated with a member that is to prepare the first resource when the processor determines that the user device will take less than the threshold time to arrive at the premises.

12. The system of claim 11, wherein the device is further configured to:
complete a purchase of the first resource or a transaction associated with the first resource.

13. The system of claim 11, wherein when the processor determines whether the user device will take less than a threshold time to arrive at a premises, the processor executes the instructions to:
obtain location information that identifies a location of the user device; and
determine an approximate amount of time that the user device will take to arrive at the premises.

14. The system of claim 13, wherein when the processor determines the approximate amount of time, the processor executes the instructions to:
determine the approximate amount of time by querying a remote device with a message, the message including at least the location information.

15. The system of claim 13, wherein when the processor determines the approximate amount of time, the processor executes the instructions to:
determine a travel sped of the user device, a moving direction of the user device, and the location of the user device; and
determine an amount of time the user device will take to reach the premises based on the travel speed, the moving direction and the location.

16. The system of claim 11, wherein the reservation information further includes at least one of:
a telephone number of the user device; a name; a time of reservation; payment information; or information that identifies the first resource.

17. The system of claim 11, further comprising:
an interface device located in the premises, configured to:
receive second reservation information from a member of the premises; and
send the second reservation information to the device,
wherein the processor further executes the instructions to reassign the second resource to the user.

18. The system of claim 11, wherein the user device includes:
a tablet computer; a smart phone; or a laptop computer.

19. The system of claim 10, wherein the processor further executes the instructions to:
send a component, to the user device, that obtains location information identifying a location of the user device when the component is in the user device.

20. A computer-readable medium comprising computer-executable instructions, the computer-executable instructions including instructions for causing one or more processors executing the instructions to:
receive reservation information from a user via a user device, the reservation information comprising information identifying a user or a user device and information identifying one or more resources that include a first resource;
select the first resource based on the information identifying the one or more resources;
determine whether the user device will take less than a threshold time to arrive at a premises; and
notify a device associated with a member that is to prepare the first resource when the one or more processors determine that the user device will take less than the threshold time to arrive at the premises.
